(19) United States
(12) Patent Application Publication
(10) Pub. No.: US 2017/0051913 A1
(43) Pub. Date: Feb. 23, 2017

(54) COMBUSTION SYSTEM WITH A PERFORATED FLAME HOLDER AND AN EXTERNAL FLUE GAS RECIRCULATION APPARATUS

(71) Applicant: ClearSign Combustion Corporation, Seattle, WA (US)

(72) Inventors: JOSEPH COLANNINO, BELLEVUE, WA (US); DOUGLAS W. KARKOW, DES MOINES, WA (US); CHRISTOPHER A. WIKLOF, EVERETT, WA (US)

(21) Appl. No.: 15/202,844

(22) Filed: Jul. 6, 2016

Related U.S. Application Data
(60) Provisional application No. 62/206,633, filed on Aug. 18, 2015.

(51) Int. Cl. F23C 9/08; F23N 3/00

(52) U.S. Cl. CPC F23C 9/08; F23N 3/002; F27D 2019/0031

(57) ABSTRACT

A combustion system includes a perforated flame holder positioned within a combustion volume, a nozzle configured to emit a fuel stream toward the perforated flame holder, an oxidant source configured to introduce an oxidizer fluid into the combustion volume, and a flue gas recirculation (FGR) channel having a first end in fluid communication with the combustion volume downstream of the perforated flame holder and a second end in fluid communication with the oxidant source. A controller is configured to hold a combustion parameter within a selected range of values by regulating a quantity of flue gas flowing in the FGR channel.

### CROSS REFERENCE TO RELATED APPLICATIONS

The present application claims priority benefit from U.S. Provisional Patent Application No. 62/206,633, entitled “COMBUSTION SYSTEM WITH A PERFORATED FLAME HOLDER AND AN EXTERNAL FLUE GAS RECIRCULATION APPARATUS,” filed Aug. 18, 2015 (docket number 2651-268-02); which, to the extent not inconsistent with the disclosure herein, is incorporated by reference.

### BACKGROUND

The term flue gas is commonly used in the art to refer to a mixture of gases flowing downstream from a combustion reaction, and typically includes products of the combustion reaction as well as other gas phase or gas entrained matter that might be present. The particular components of flue gas vary according a number of factors, such as, e.g., the composition of the fuel, composition of the air or other oxygen-containing fluid that supports the reaction, the temperature and duration of the combustion reaction, etc. For example, flue gas can include nitrogen (N₂), water (H₂O), carbon dioxide (CO₂), residual oxygen (O₂), carbon monoxide (CO), oxides of nitrogen (NOx), particulate matter (PM), un-combusted or partially combusted fuel, sulfur compounds, etc.

Many of the flue gas components that can be produced in a combustion reaction are considered to be pollutants, and are therefore regulated, with respect to their concentration in emissions from commercial combustion systems. Compliance with such regulations by many existing combustion systems can be difficult and/or expensive.

### SUMMARY

According to an embodiment, a combustion system includes a perforated flame holder disposed in a combustion volume defined by a combustion chamber wall, the perforated flame holder being configured to hold a combustion reaction supported by the fuel and combustion air; a fuel and oxidant source configured to output fuel and combustion air into the combustion volume and arranged to cause the fuel and air to mix in a mixing volume between the fuel and oxidant source and the perforated flame holder, and a flue gas recirculator (e.g., an external flue gas recirculator) configured to receive flue gas from a flue volume arranged to receive the flue gas from the combustion reaction held by the perforated flame holder and output the flue gas for mixing with the fuel and air in the mixing volume.

According to an embodiment, a combustion system is provided that includes a perforated flame holder positioned within a combustion volume, a nozzle configured to emit a fuel stream toward the perforated flame holder, an oxidant source configured to introduce an oxidizer fluid into the combustion volume, and a flue gas recirculation (FGR) channel having a first end in fluid communication with the combustion volume downstream of the perforated flame holder and a second end in fluid communication with the oxidant source. A controller is configured to hold a combustion parameter within a selected range of values by regulating a quantity of flue gas flowing in the FGR channel.

According to an embodiment, a combustion system is provided that comprises a perforated flame holder having an input face, an output face lying opposite the input face, and a plurality of perforations extending through the flame holder between the input and output faces. The flame holder is positioned within a combustion volume and is configured to hold a combustion reaction substantially within the plurality of perforations. A fuel nozzle is positioned and configured to emit a fuel stream toward the input face of the perforated flame holder, and an oxidant source is configured to introduce an oxidizer fluid into the combustion volume. A flue gas recirculation channel is provided that includes a first end in fluid communication with the combustion volume downstream of the perforated flame holder and a second end in fluid communication with the oxidant source.

According to an embodiment, a controller is configured to regulate a volume of flue gas flowing in the flue gas recirculation channel according to a parameter of the combustion reaction. A flue gas sensor can be configured to detect a value of the parameter of the combustion reaction and to transmit a signal to the controller that corresponds to the detected value. According to another embodiment, the controller is configured to regulate the volume of flue gas according to a plurality of parameters of the combustion reaction.

According to an embodiment, the controller is configured to monitor parameters associated with a working load of the system, and to control operation of the system to maintain those parameters within a selected range.

### BRIEF DESCRIPTION OF THE DRAWINGS

FIG. 1 is a diagram of a system including a burner with a perforated flame holder and an external flue gas recirculation (EFGR) system, according to an embodiment.

FIG. 2 is a simplified perspective view of a burner system including a perforated flame holder, according to an embodiment.

FIG. 3 is side sectional diagram of a portion of the perforated flame holder of FIGS. 1 and 2, according to an embodiment.

FIG. 4 is a flow chart showing a method for operating a burner system including the perforated flame holder of FIGS. 1, 2 and 3, according to an embodiment.

FIG. 5 is a diagram of a combustion system with a perforated flame holder, and including flue gas recirculation, according to an embodiment.

FIG. 6 is a side sectional diagram of a combustion system, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

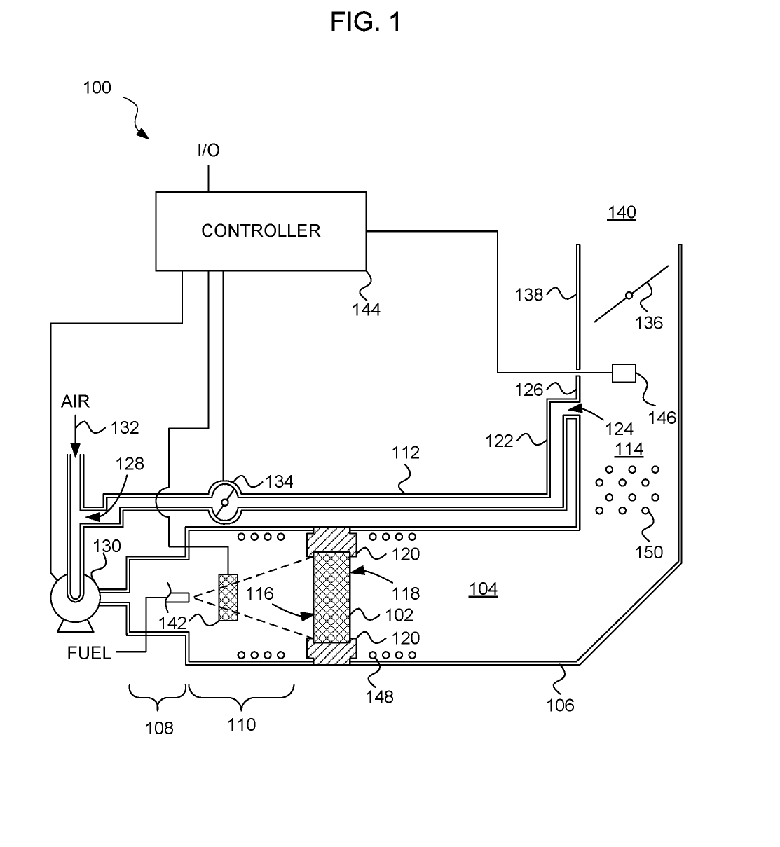

FIG. 1 is a diagram of a combustion system 100 including an external flue gas recirculator 112, according to an embodiment. For example, the combustion system 100 can be a once-through-steam generator (OTSG). The combustion system 100 includes a perforated flame holder 102 disposed in a combustion volume 104 defined by a combustion chamber wall 106, the perforated flame holder 102 being configured to hold a combustion reaction supported by fuel and combustion air. A fuel and oxidant source 108 is configured to output fuel and combustion air into the combustion volume 104 and is arranged to cause the fuel and air to mix in a mixing volume 110 located between the fuel and oxidant source 108 and the perforated flame holder 102. A perforated flame holder support structure 120 can be configured to support the perforated flame holder 102 at a distance including the mixing volume 110 away from the fuel and oxidant source 108.

An external flue gas recirculator 112 can be configured to receive flue gas from a flue volume 114 arranged to receive the flue gas from the combustion reaction held by the perforated flame holder 102 and output the flue gas for mixing with the fuel and oxidant in the mixing volume 110.

In an embodiment, the perforated flame holder 102 is configured to hold, under at least a subset of operating conditions of the combustion system 100, the combustion reaction substantially between an input face 116 and an output face 118 of the perforated flame holder 102.

In an embodiment, the flue gas recirculator 112 is an external flue gas recirculation (EFGR) system. The external flue gas recirculator 112 can include a pipe or duct 122 arranged to convey flue gas received from an aperture 124 in a flue wall 126 adjacent to the flue volume 114 to an output point 128 into an air intake channel for mixture with incoming combustion air (as shown). In another embodiment, the flue gas recirculator 112 includes a pipe or duct 122 arranged to convey flue gas received from an aperture 124 in a flue wall 126 adjacent to the flue volume 114 to the fuel and oxidant source 108. In another embodiment, the external flue gas recirculator 112 can include a pipe or duct 122 arranged to convey flue gas received from an aperture 124 in a flue wall 126 adjacent to the flue volume 114 to the mixing volume 110.

A blower 130 can be configured to receive the flue gas conveyed by the pipe 122 and input air 132, and to output the flue gas and input air 132 into the fuel and oxidant source 108. The blower 130 can be arranged in various ways relative to the input air source and the external flue gas recirculator 112.

The external flue gas recirculator 112 can include the blower (either the same as or different than the blower 130 that propels combustion air) arranged to suck flue gas from the flue gas volume 114 and output the flue gas for mixing with the fuel and air prior to receipt of the mixed fuel, air, and flue gas at the input face 116 of the perforated flame holder 102. Optionally, a pair of blowers can separately pressurize input air 132 and flue gas to be introduced separately into the mixing volume 110.

The external flue gas recirculator 112 can include a recirculation valve or damper 134 configured to control the flow of flue gas through the external flue gas recirculator 112. The combustion system 100 can include a damper 136 configured to control a flow of flue gas out a stack 138 to the atmosphere 140. The external flue gas recirculator 112 can include ductwork maintained under a small partial vacuum by the blower 130, which can advantageously reduce fugitive emissions at damper fittings, etc.

A start-up apparatus 142 is configured to pre-heat the perforated flame holder 102 during start-up from a temperature below a nominal operating temperature of the perforated flame holder 102. A controller 144 can be operatively coupled to the start-up apparatus 142 and the recirculation valve or damper 134. The controller 144 can be configured to substantially prevent external recirculation of flue gas while the start-up apparatus 142 is pre-heating the perforated flame holder 102. Additionally or alternatively, the controller 144 can be operatively coupled to the start-up apparatus 142 and the blower 130.

The controller 144 can be configured to control (or output a prompt onto a computer display screen to cause an operator to control) the blower 130 and/or damper 134 to substantially prevent external recirculation of flue gas while the start-up apparatus 142 is pre-heating the perforated flame holder 102. In one embodiment, the blower 130 includes actuated vanes (not shown) that control the relative impelling efficiency of combustion air and flue gas. The controller 144 can be operatively coupled to the vanes to control the relative volume of combustion air and flue gas in the mixture delivered to the perforated flame holder 102.

In an embodiment, the combustion system 100 can include a controller 144, a flue gas sensor 146 operatively coupled to the controller 144, and at least one apparatus (such as a flue gas blower 130 and/or a damper 134) configured to control a flow of flue gas into the combustion volume 104. The controller can be configured to control the at least one apparatus 130, 134 to cause flue gas to flow into the combustion volume 104 only when the flue gas sensor 146 outputs a signal indicating that the perforated flame holder 102 is at a nominal operating temperature or above (or from which such an inference can be made). For example, the sensor 146 can include a stack temperature sensor that detects a sequence of temperatures. As the perforated flame holder 102 is heated sufficiently, it sinks less and less heat from a start-up flame supported by the start-up apparatus 142, and the temperature in the stack 138 approaches a start-up steady-state value. In experiments, the inventors transitioned systems 100 into the perforated flame holder 102—supported combustion when stack temperatures range from 850 to 1000 degrees F. In another embodiment, the sensor 146 can include a carbon monoxide sensor. A carbon monoxide sensor is illustrative of a class of sensors from which proper start-up conditions for the perforated flame holder 102 can be inferred, if not directly sensed. The inventors have found that, during a transitory period corresponding to system start-up, when the perforated flame holder 102 is relatively cool (below a start up flame holder temperature), combustion may be relatively incomplete, causing carbon monoxide (CO) concentration in the stack 138 to be relatively high. As the perforated flame holder 102 is raised to higher and higher temperature by the start-up apparatus 142, heat from the perforated flame holder body is output to maintain the reactants (including CO) at a high enough temperature for sufficient time for CO to oxidize more fully to (carbon dioxide) CO₂.

Upon the perforated flame holder 102 reaching a temperature sufficient for start up, fuel and combustion air are allowed to flow to the perforated flame holder 102 for combustion.

During full scale experiments, after combustion had transitioned to the perforated flame holder 102, the inventors found that providing a small amount of external flue gas recirculation (EFGR) (about 5% of total flow) reduced an output of oxides of nitrogen (NOx) from about 5 ppm to about 2 ppm, but at a cost of adding detectable CO to the flue 114. Larger amounts of EFGR reduced NOx further, but at a cost of significantly increased CO. Accordingly, the inventors recommend maintaining EFGR at a relatively low flow rate such as 5% of total flow.

Despite the increased CO, the system 100 provided a favorable result. While CO is toxic, it eventually (e.g., in the stack or an exhaust plume) tends to react to form CO₂. Thus small to moderate increases in CO may be viewed as an acceptable trade off for reducing NOx further. Unlike CO, which further reacts to form the non-toxic and relatively abundant species CO₂, NOx (first in the form NO, and later in the form NO₂) tends to react further to produce ozone, a pollutant when in the lower atmosphere.

The combustion system 100 can include a radiantly-heated heat load 148 configured to receive infrared radiation from the perforated flame holder 102 and a convectively-heated heat load 150 configured to receive heat from hot combustion products output by the combustion reaction held by the perforated flame holder 102. This was the arrangement used in full scale experiments wherein the combustion system 100 was a OTSG. The inventors found that adding the perforated flame holder 102 to the OTSG resulted in a decrease in NOx output from double-digit to low single-digit parts per million.

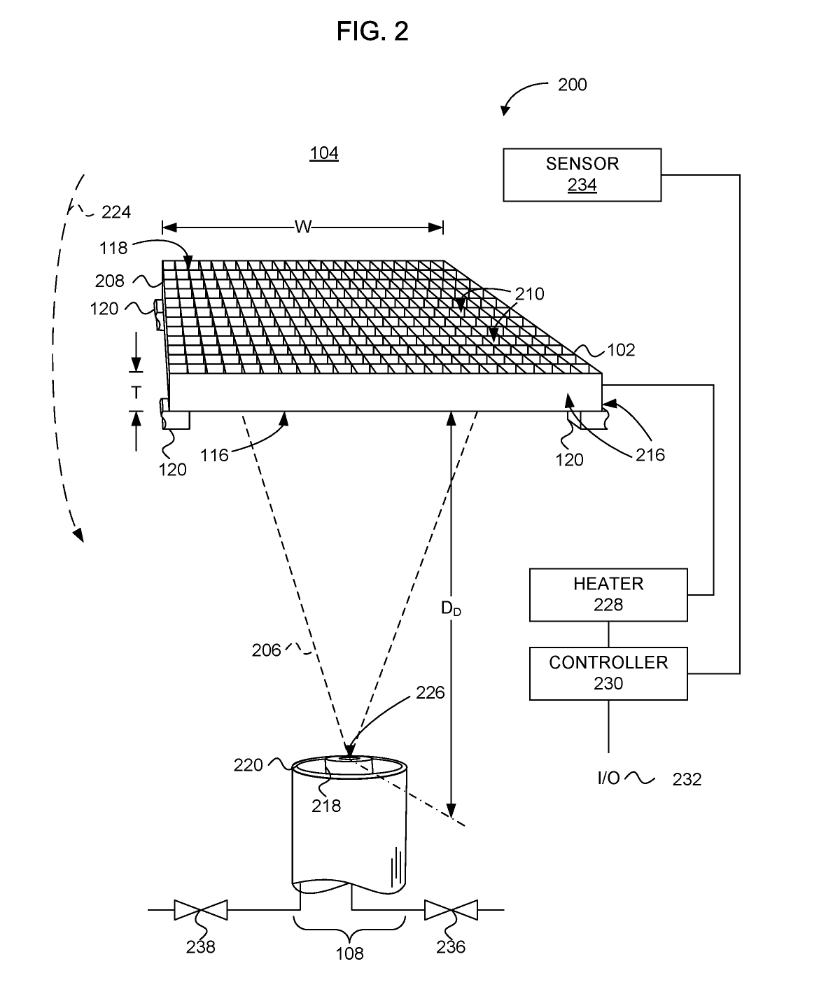

FIG. 2 is a simplified diagram of a burner system 200 including a perforated flame holder 102 configured to hold a combustion reaction, according to an embodiment. As used herein, the terms perforated flame holder, perforated reaction holder, porous flame holder, and porous reaction holder shall be considered synonymous unless further definition is provided. Experiments performed by the inventors have shown that perforated flame holders 102 described herein can support very clean combustion. Specifically, in experimental use of systems 200 ranging from pilot scale to full scale, output of NOx was measured to range from low single digit parts per million down to undetectable (less than 1 part per million) concentration of NOx at the stack.

These remarkable results were measured at 3% (dry) oxygen (O₂) concentration with undetectable CO at stack temperatures typical of industrial furnace applications (1400-1600° F.). Moreover, these results did not require any extraordinary measures such as selective catalytic reduction (SCR), selective non-catalytic reduction (SNCR), water/steam injection, or other heroic extremes that may be required for conventional burners to even approach such clean combustion.

According to embodiments, the burner system 200 includes a fuel and oxidant source 108 disposed to output fuel and oxidant into a combustion volume 104 to form a fuel and oxidant mixture 206. As used herein, the terms combustion volume, combustion chamber, furnace volume, and the like shall be considered synonymous unless further definition is provided. The perforated flame holder 102 is disposed in the combustion volume 104 and positioned to receive the fuel and oxidant mixture 206.

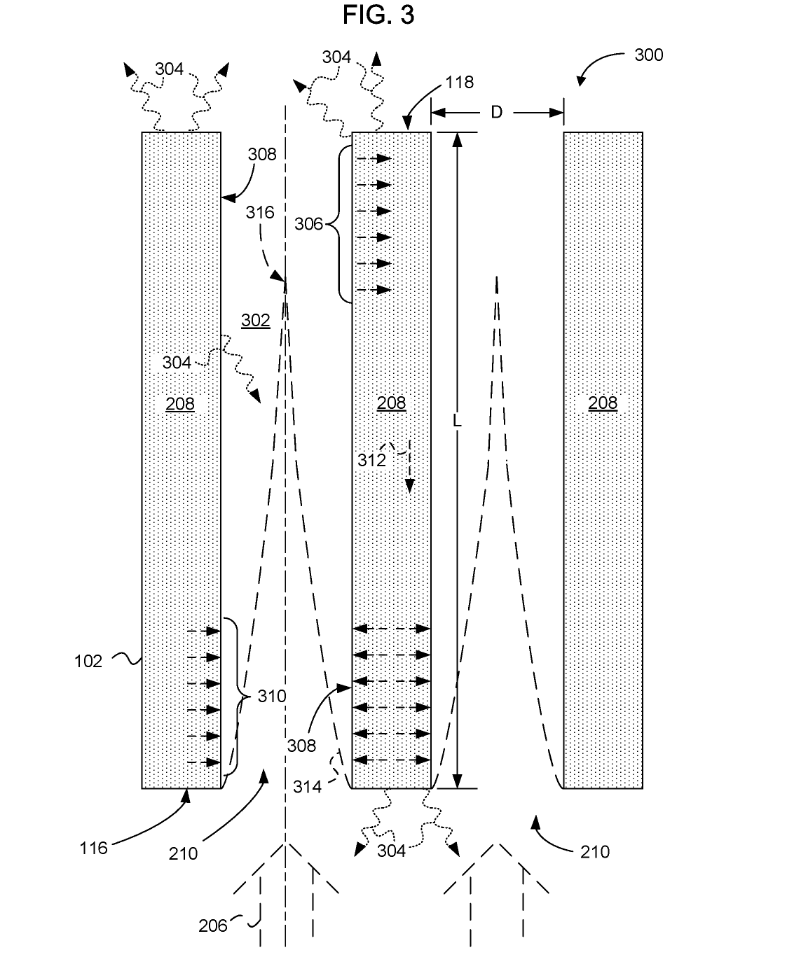

FIG. 3 is side sectional diagram 300 of a portion of the perforated flame holder 102 of FIGS. 1 and 2, according to an embodiment. Referring to FIGS. 2 and 3, the perforated flame holder 102 includes a perforated flame holder body 208 defining a plurality of perforations 210 aligned to receive the fuel and oxidant mixture 206 from the fuel and oxidant source 108. As used herein, the terms perforation, pore, aperture, elongated aperture, and the like, in the context of the perforated flame holder 102, shall be considered synonymous unless further definition is provided. The perforations 210 are configured to collectively hold a combustion reaction 302 supported by the fuel and oxidant mixture 206.

The fuel can include hydrogen, a hydrocarbon gas, a vaporized hydrocarbon liquid, an atomized hydrocarbon liquid, or a powdered or pulverized solid. The fuel can be a single species or can include a mixture of gas(es), vapor(s), atomized liquid(s), and/or pulverized solid(s). For example in a process heater application, the fuel can include fuel gas or byproducts from the process that include CO, hydrogen (H₂), and methane (CH₄). In another application the fuel can include natural gas (mostly CH₄) or propane (C₃H₈). In another application, the fuel can include #2 fuel oil or #6 fuel oil. Dual fuel applications and flexible fuel applications are similarly contemplated by the inventors. The oxidant can include oxygen carried by air and/or can include another oxidant, either pure or carried by a carrier gas. The terms oxidant and oxidizer shall be considered synonymous herein.

According to an embodiment, the perforated flame holder body 208 can be bounded by an input face 116 disposed to receive the fuel and oxidant mixture 206, an output face 118 facing away from the fuel and oxidant source 108, and a peripheral surface 216 defining a lateral extent of the perforated flame holder 102. The plurality of perforations 210 which are defined by the perforated flame holder body 208 extend from the input face 116 to the output face 118. The plurality of perforations 210 can receive the fuel and oxidant mixture 206 at the input face 116. The fuel and oxidant mixture 206 can then combust in or near the plurality of perforations 210 and combustion products can exit the plurality of perforations 210 at or near the output face 118.

According to an embodiment, the perforated flame holder 102 is configured to hold a majority of the combustion reaction 302 within the perforations 210. For example, on a steady-state basis, more than half the molecules of fuel output into the combustion volume 104 by the fuel and oxidant source 108 may be converted to combustion products between the input face 116 and the output face 118 of the perforated flame holder 102. According to an alternative interpretation, more than half of the heat output by the combustion reaction 302 may be output between the input face 116 and the output face 118 of the perforated flame holder 102. Under nominal operating conditions, the perforations 210 can be configured to collectively hold at least 80% of the combustion reaction 302 between the input face 116 and the output face 118 of the perforated flame holder 102. In some experiments, the inventors produced a combustion reaction that was apparently wholly contained in the perforations 210 between the input face 116 and the output face 118 of the perforated flame holder 102. According to an alternative interpretation, the perforated fame holder 102 can support combustion between the input face 116 and output face 118 when combustion is “time-averaged”. For example, during transients, such as before the perforated flame holder 102 is fully heated, or if too high a (cooling) load is placed on the system, the combustion may travel somewhat downstream from the output face 118 of the perforated flame holder 102.

While a “flame” is described in a manner intended for ease of description, it should be understood that in some instances, no visible flame is present. Combustion occurs primarily within the perforations 210, but the “glow” of combustion heat is dominated by a visible glow of the perforated flame holder 102 itself. In other instances, the inventors have noted transient “huffing” wherein a visible flame momentarily ignites in a region lying between the input face 116 of the perforated flame holder 102 and the fuel source 218, within the dilution region D_{D}. Such transient huffing is generally short in duration such that, on a time-averaged basis, a majority of combustion occurs within the perforations 210 of the perforated flame holder 102, between the input face 116 and the output face 118. In still other instances, the inventors have noted apparent combustion occurring above the output face 118 of the perforated flame holder 102, but still a majority of combustion occurred within the perforated flame holder 102 as evidenced by the continued visible glow (a visible wavelength tail of blackbody radiation) from the perforated flame holder 102.

The perforated flame holder 102 can be configured to receive heat from the combustion reaction 302 and output a portion of the received heat as thermal radiation 304 to heat-receiving structures (e.g., furnace walls and/or radiant section working fluid tubes) in or adjacent to the combustion volume 104. As used herein, terms such as thermal radiation, infrared radiation, radiant heat, heat radiation, etc. are to be construed as being substantially synonymous, unless further definition is provided. Specifically, such terms refer to blackbody radiation of electromagnetic energy, primarily in infrared wavelengths.

Referring especially to FIG. 3, the perforated flame holder 102 outputs another portion of the received heat to the fuel and oxidant mixture 206 received at the input face 116 of the perforated flame holder 102. The perforated flame holder body 208 may receive heat from the (exothermic) combustion reaction 302 at least in heat receiving regions 306 of perforation walls 308. Experimental evidence has suggested to the inventors that the position of the heat receiving regions 306, or at least the position corresponding to a maximum rate of receipt of heat, can vary along the length of the perforation walls 308. In some experiments, the location of maximum receipt of heat was apparently between ⅓ and ½ of the distance from the input face 116 to the output face 118 (i.e., somewhat nearer to the input face 116 than to the output face 118). The inventors contemplate that the heat receiving regions 306 may lie nearer to the output face 118 of the perforated flame holder 102 under other conditions. Most probably, there is no clearly defined edge of the heat receiving regions 306 (or for that matter, the heat output regions 310, described below). For ease of understanding, the heat receiving regions 306 and the heat output regions 310 will be described as particular regions 306, 310.

The perforated flame holder body 208 can be characterized by a heat capacity. The perforated flame holder body 208 may hold heat from the combustion reaction 302 in an amount corresponding to the heat capacity times temperature rise, and transfer the heat from the heat receiving regions 306 to heat output regions 310 of the perforation walls 308. Generally, the heat output regions 310 are nearer to the input face 116 than are the heat receiving regions 306. According to one interpretation, the perforated flame holder body 208 can transfer heat from the heat receiving regions 306 to the heat output regions 310 via thermal radiation, depicted graphically as 304. According to another interpretation, the perforated flame holder body 208 can transfer heat from the heat receiving regions 306 to the heat output regions 310 via heat conduction along heat conduction paths 312. The inventors contemplate that both radiation and conduction heat transfer mechanisms may be operative in transferring heat from the heat receiving regions 306 to the heat output regions 310. In this way, the perforated flame holder 102 may act as a heat source to maintain the combustion reaction 302, even under conditions where a combustion reaction would not be stable when supported from a conventional flame holder.

The inventors believe that the perforated flame holder 102 causes the combustion reaction 302 to occur within thermal boundary layers 314 formed adjacent to walls 308 of the perforations 210. As the relatively cool fuel and oxidant mixture 206 approaches the input face 116, the flow is split into portions that respectively travel through individual perforations 210. The hot perforated flame holder body 208 transfers heat to the fluid, notably within thermal boundary layers 314 that progressively thicken as more and more heat is transferred to the incoming fuel and oxidant mixture 206. After reaching a combustion temperature (e.g. the auto-ignition temperature of the fuel), the reactants continue to flow while a chemical ignition delay time elapses, over which time the combustion reaction 302 occurs. Accordingly, the combustion reaction 302 is shown as occurring within the thermal boundary layers 314. As flow progresses, the thermal boundary layers 314 merge at a merger point 316. Ideally, the merger point 316 lies between the input face 116 and output face 118 that defines the ends of the perforations 210. At some point, the combustion reaction 302 causes the flowing gas (and plasma) to output more heat to the body 208 than it receives from the body 208. The heat is received at the heat receiving region 306, is held by the body 208, and is transported to the heat output region 310 nearer to the input face 116, where the heat recycles into the cool reactants (and any included diluent) to raise them to the combustion temperature.

In an embodiment, the plurality of perforations 210 are each characterized by a length L defined as a reaction fluid propagation path length between the input face 116 and the output face 118 of the perforated flame holder 102. The reaction fluid includes the fuel and oxidant mixture 206 (optionally including nitrogen, flue gas, and/or other “non-reactive” species), reaction intermediates (including transition states in a plasma that characterizes the combustion reaction), and reaction products.

The plurality of perforations 210 can be each characterized by a transverse dimension D between opposing perforation walls 308. The inventors have found that stable combustion can be maintained in the perforated flame holder 102 if the length L of each perforation 210 is at least four times the transverse dimension D of the perforation. In other embodiments, the length L can be greater than six times the transverse dimension D. For example, experiments have been run where L is at least eight, at least twelve, at least sixteen, and at least twenty-four times the transverse dimension D. Preferably, the length L is sufficiently long for thermal boundary layers 314 formed adjacent to the perforation walls 308 in a reaction fluid flowing through the perforations 210 to converge at merger points 316 within the perforations 210 between the input face 116 and the output face 118 of the perforated flame holder 102. In experiments, the inventors have found L/D ratios between 12 and 48 to work well (i.e., produce low NOx, produce low CO, and maintain stable combustion).

The perforated flame holder body 208 can be configured to convey heat between adjacent perforations 210. The heat conveyed between adjacent perforations 210 can be selected to cause heat output from the combustion reaction portion 302 in a first perforation 210 to supply heat to stabilize a combustion reaction portion 302 in an adjacent perforation 210.

Referring especially to FIG. 2, the fuel and oxidant source 108 can further include a fuel nozzle 218, configured to output fuel, and an oxidant source 220 configured to output a fluid including the oxidant. For example, the fuel nozzle 218 can be configured to output pure fuel. The oxidant source 220 can be configured to output combustion air carrying oxygen.

The perforated flame holder 102 can be held by the perforated flame holder support structure 120 configured to hold the perforated flame holder 102 a distance D_{D} away from the fuel nozzle 218. The fuel nozzle 218 can be configured to emit a fuel jet selected to entrain the oxidant to form the fuel and oxidant mixture 206 as the fuel jet and oxidant travel along a path to the perforated flame holder 102 through a dilution distance D_{D} between the fuel nozzle 218 and the perforated flame holder 102. Additionally or alternatively (particularly when a blower is used to deliver oxidant combustion air), the oxidant or combustion air source can be configured to entrain the fuel, and the fuel and oxidant travel through the dilution distance D_{D}. In some systems, an internal flue gas recirculation (FGR) path 224 can be inferred. This type of natural internal FGR 224 can be caused, for example, by vortices that can drive upstream propagation of flue gas through any area of the combustion volume 104 peripheral to the perforated flame holder 102 and inside the combustion chamber wall 106 (e.g., see FIG. 1). As used herein, the terms external flue gas recirculation, EFGR or, in shortened form, flue gas recirculation, FGR, are to be understood to be exclusive of any internal flue gas recirculation 224 that may or may not also be present. Similarly, the term flue gas recirculator is to be understood as exclusive of any space continuous with the combustion volume 104 (through which incidental internal flue gas recirculation may occur). A flue gas recirculator or FGR channel is a structure that is intended to move flue gas from the stack 138 (or other region downstream from the perforated flame holder 102) to the mixing volume 110. Additionally or alternatively, the fuel nozzle 218 can be configured to emit a fuel jet selected to entrain the oxidant and to entrain flue gas as the fuel jet travels through a dilution distance D_{D} between the fuel nozzle 218 and the input face 116 of the perforated flame holder 102.

The fuel nozzle 218 can be configured to emit the fuel through one or more fuel orifices 226 having a dimension that is referred to as “nozzle diameter”. The perforated flame holder support structure 120 can support the perforated flame holder 102 to receive the fuel and oxidant mixture 206 at a distance D_{D} away from the fuel nozzle 218 greater than 20 times the nozzle diameter. In another embodiment, the perforated flame holder 102 is disposed to receive the fuel and oxidant mixture 206 at a distance D_{D} away from the fuel nozzle 218 between 100 times and 1100 times the nozzle diameter. Preferably, the perforated flame holder support structure 120 is configured to hold the perforated flame holder 102 about 200 times the nozzle diameter or more away from the fuel nozzle 218. When the fuel and oxidant mixture 206 travels about 200 times the nozzle diameter or more, the mixture is sufficiently homogenized to cause the combustion reaction to output minimal NOx.

The fuel and oxidant source 108 can alternatively include a premix fuel and oxidant source, according to an embodiment. A premix fuel and oxidant source can include a premix chamber (not shown), a fuel nozzle configured to output fuel into the premix chamber, and an air channel configured to output combustion air into the premix chamber. A flame arrestor can be disposed between the premix fuel and oxidant source and the perforated flame holder 102 and be configured to prevent flame flashback into the premix fuel and oxidant source.

The combustion air source, whether configured for entrainment in the combustion volume 104 or for premixing can include a blower configured to force air through the fuel and air source 108.

The support structure 120 can be configured to support the perforated flame holder 102 from a floor or wall (not shown) of the combustion volume 104, for example. In another embodiment, the support structure 120 supports the perforated flame holder 102 from the fuel and oxidant source 108. Alternatively, the support structure 120 can suspend the perforated flame holder 102 from an overhead structure (such as a flue, in the case of an up-fired system). The support structure 120 can support the perforated flame holder 102 in various orientations and directions.

The perforated flame holder 102 can include a single perforated flame holder body 208. In another embodiment, the perforated flame holder 102 can include a plurality of adjacent perforated flame holder sections that collectively provide a tiled perforated flame holder 102.

The perforated flame holder support structure 120 can be configured to support the plurality of perforated flame holder sections. The perforated flame holder support structure 120 can include a metal superalloy, a cementatious, and/or ceramic refractory material. In an embodiment, the plurality of adjacent perforated flame holder sections can be joined with a fiber reinforced refractory cement.

The perforated flame holder 102 can have a width dimension W between opposite sides of the peripheral surface 216 at least twice a thickness dimension T between the input face 116 and the output face 118. In another embodiment, the perforated flame holder 102 can have a width dimension W between opposite sides of the peripheral surface 216 at least three times, at least six times, or at least nine times a thickness dimension T between the input face 116 and the output face 118 of the perforated flame holder 102.

In an embodiment, the perforated flame holder 102 can have a width dimension W less than a width of the combustion volume 104. This can allow the FGR path 224 from above to below the perforated flame holder 102 to lie between the peripheral surface 216 of the perforated flame holder 102 and the combustion volume wall (not shown).

Referring again to both FIGS. 2 and 3, the perforations 210 can include elongated squares, each of the elongated squares has a transverse dimension D between opposing sides of the squares. In another embodiment, the perforations 210 can include elongated hexagons, each of the elongated hexagons has a transverse dimension D between opposing sides of the hexagons. In another embodiment, the perforations 210 can include hollow cylinders, each of the hollow cylinders has a transverse dimension D corresponding to a diameter of the cylinders. In another embodiment, the perforations 210 can include truncated cones, each of the truncated cones has a transverse dimension D that is rotationally symmetrical about a length axis that extends from the input face 116 to the output face 118. The perforations 210 can each have a lateral dimension D equal to or greater than a quenching distance of the fuel based on standard reference conditions.

In one range of embodiments, each of the plurality of perforations has a lateral dimension D between 0.05 inch and 1.0 inch. Preferably, each of the plurality of perforations 210 has a lateral dimension D between 0.1 inch and 0.5 inch. For example the plurality of perforations 210 can each have a lateral dimension D of about 0.2 to 0.4 inch.

The void fraction of a perforated flame holder 102 is defined as the total volume of all perforations 210 in a section of the perforated flame holder 102 divided by a total volume of the perforated flame holder including body 208 and perforations 210. The perforated flame holder 102 should have a void fraction between 0.10 and 0.90. In an embodiment, the perforated flame holder 102 can have a void fraction between 0.30 and 0.80. In another embodiment, the perforated flame holder 102 can have a void fraction of about 0.70. Using a void fraction of about 0.70 was found to be especially effective for producing very low NOx.

The perforated flame holder 102 can be formed from a fiber reinforced cast refractory material and/or a refractory material such as an aluminum silicate material. For example, the perforated flame holder 102 can be formed from mullite or cordierite. Additionally or alternatively, the perforated flame holder body 208 can include a metal superalloy such as Inconel or Hastelloy. The perforated flame holder body 208 can define a honeycomb.

The inventors have found that the perforated flame holder 102 can be formed from VERSAGRID® ceramic honeycomb, available from Applied Ceramics, Inc. of Doraville, S.C.

The perforations 210 can be parallel to one another and normal to the input and output faces 116, 118. In another embodiment, the perforations 210 can be parallel to one another and formed at an angle relative to the input and output faces 116, 118. In another embodiment, the perforations 210 can be non-parallel to one another. In another embodiment, the perforations 210 can be non-parallel to one another and non-intersecting. In another embodiment, the perforations 210 can be intersecting. The body 208 can be one piece or can be formed from a plurality of sections.

In another embodiment, which is not necessarily preferred, the perforated flame holder 102 may be formed from reticulated fibers formed from an extruded ceramic material. The term “reticulated fibers” refers to a netlike structure.

In another embodiment, the perforated flame holder 102 can include a plurality of tubes or pipes bundled together. The plurality of perforations 210 can include hollow cylinders and can optionally also include interstitial spaces between the bundled tubes. In an embodiment, the plurality of tubes can include ceramic tubes. Refractory cement can be included between the tubes and configured to adhere the tubes together. In another embodiment, the plurality of tubes can include metal (e.g., superalloy) tubes. The plurality of tubes can be held together by a metal tension member circumferential to the plurality of tubes and arranged to hold the plurality of tubes together. The metal tension member can include stainless steel, a superalloy metal wire, and/or a superalloy metal band.

The perforated flame holder body 208 can alternatively include stacked perforated sheets of material, each sheet having openings that connect with openings of subjacent and superjacent sheets. The perforated sheets can include perforated metal sheets, ceramic sheets and/or expanded sheets. In another embodiment, the perforated flame holder body 208 can include discontinuous packing bodies such that the perforations 210 are formed in the interstitial spaces between the discontinuous packing bodies. In one example, the discontinuous packing bodies include structured packing shapes. In another example, the discontinuous packing bodies include random packing shapes. For example, the discontinuous packing bodies can include ceramic Raschig ring, ceramic Berl saddles, ceramic Intalox saddles, and/or metal rings or other shapes (e.g. Super Raschig Rings) that may be held together by a metal cage.

The inventors contemplate various explanations for why burner systems including the perforated flame holder 102 provide such clean combustion.

In one aspect, the perforated flame holder 102 acts as a heat source to maintain a combustion reaction even under conditions where a combustion reaction would not be stable when supported by a conventional flame holder. This capability can be leveraged to support combustion using a leaner fuel-to-oxidant mixture than is typically feasible. Thus, according to an embodiment, at the point where the fuel stream 206 contacts the input face 116 of the perforated flame holder 102, an average fuel-to-oxidant ratio of the fuel stream 206 is below a (conventional) lower combustion limit of the fuel component of the fuel stream—lower combustion limit defines the lowest concentration of fuel at which a fuel/air mixture will burn when exposed to a momentary ignition source under normal atmospheric pressure and an ambient temperature of 25° C. (77° F.).

According to one interpretation, the fuel and oxidant mixtures supported by the perforated flame holder may be more fuel-lean than mixtures that would provide stable combustion in a conventional burner. Combustion near a lower combustion limit of fuel generally burns at a lower adiabatic flame temperature than mixtures near the center of the lean-to-rich combustion limit range. Lower flame temperatures generally evolve a lower concentration of NOx than higher flame temperatures. In conventional flames, too-lean combustion is generally associated with high CO concentration at the stack. In contrast, the perforated flame holder 102 and systems including the perforated flame holder 102 described herein were found to provide substantially complete combustion of CO (single digit parts per million down to undetectable, depending on experimental conditions), while supporting low NOx. In some embodiments, the inventors achieved stable combustion at what was understood to be very lean mixtures (that nevertheless produced only about 3% or lower measured O₂ concentration at the stack). Moreover, the inventors believe perforation walls 308 may act as a heat sink for the combustion fluid. This effect may alternatively or additionally reduce combustion temperature.

According to another interpretation, production of NOx can be reduced if the combustion reaction 302 occurs over a very short duration of time. Rapid combustion causes the reactants (including oxygen and entrained nitrogen) to be exposed to NOx-formation temperature for a time too short for NOx-formation kinetics to cause significant production of NOx. The time required for the reactants to pass through the perforated flame holder 102 is very short compared to a conventional flame. The low NOx production associated with perforated flame holder combustion may thus be related to the short duration of time required for the reactants (and entrained nitrogen) to pass through the perforated flame holder 102.

Since CO oxidation is a relatively slow reaction, the time for passage through the perforated flame holder (perhaps plus time passing toward the flue from the perforated flame holder 102) is apparently sufficient and at sufficiently elevated temperature, in view of the very low measured (experimental and full scale) CO concentrations, for oxidation of CO to carbon dioxide (CO₂).

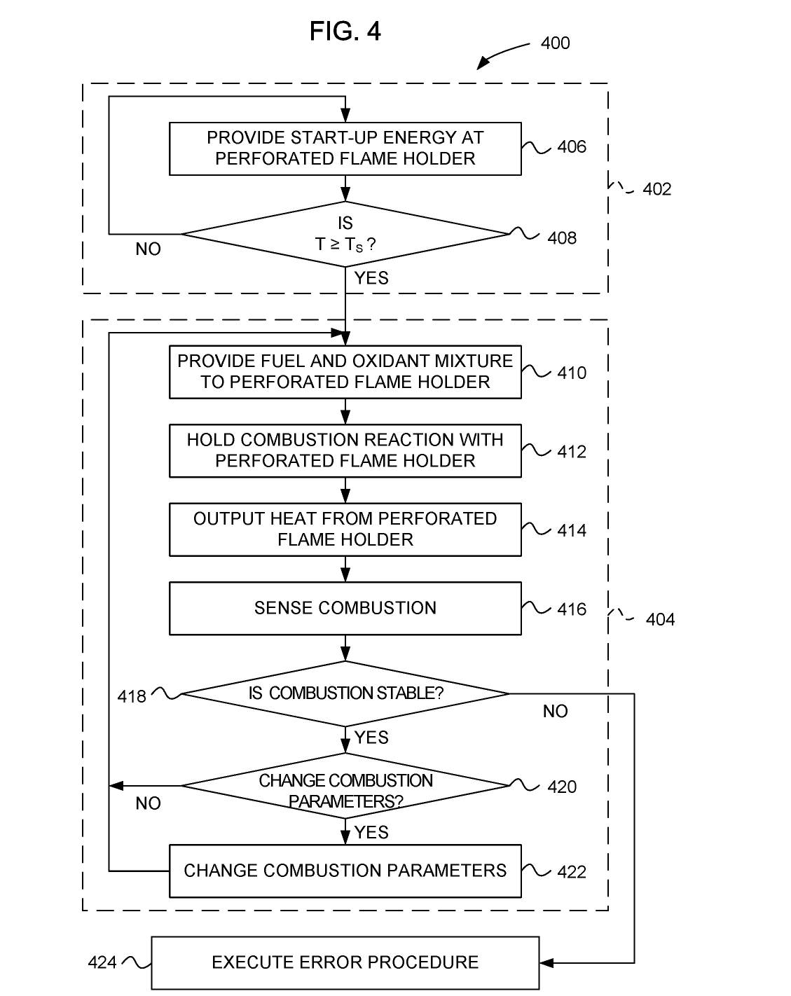

FIG. 4 is a flow chart showing a method 400 for operating a burner system including the perforated flame holder shown and described herein. To operate a burner system including a perforated flame holder, the perforated flame holder is first heated to a temperature sufficient to maintain combustion of the fuel and oxidant mixture.

According to a simplified description, the method 400 begins with step 402, wherein the perforated flame holder is preheated to a start-up temperature, T_{S}. After the perforated flame holder is raised to the start-up temperature, the method proceeds to step 404, wherein fuel and oxidant are provided to the perforated flame holder and combustion is held by the perforated flame holder.

According to a more detailed description, step 402 begins with step 406, wherein start-up energy is provided at the perforated flame holder. Simultaneously or following providing start-up energy, a decision step 408 determines whether the temperature T of the perforated flame holder is at or above the start-up temperature, T_{S}. As long as the temperature of the perforated flame holder is below its start-up temperature, the method loops between steps 406 and 408 within the preheat step 402. In step 408, if the temperature T of at least a predetermined portion of the perforated flame holder is greater than or equal to the start-up temperature, the method 400 proceeds to overall step 404, wherein fuel and oxidant is supplied to and combustion is held by the perforated flame holder.

Step 404 may be broken down into several discrete steps, at least some of which may occur simultaneously.

Proceeding from step 408, a fuel and oxidant mixture is provided to the perforated flame holder, as shown in step 410. The fuel and oxidant may be provided by a fuel and oxidant source that includes a separate fuel nozzle and combustion air source, for example. In this approach, the fuel and combustion air are output in one or more directions selected to cause the fuel and combustion air mixture to be received by an input face of the perforated flame holder. The fuel may entrain the combustion air (or alternatively, the combustion air may dilute the fuel) to provide a fuel and oxidant mixture at the input face of the perforated flame holder at a fuel dilution selected for a stable combustion reaction that can be held within the perforations of the perforated flame holder.

Proceeding to step 412, the combustion reaction is held by the perforated flame holder.

In step 414, heat may be output from the perforated flame holder. The heat output from the perforated flame holder may be used to power an industrial process, heat a working fluid, generate electricity, or provide motive power, for example.

In optional step 416, the presence of combustion may be sensed. Various sensing approaches have been used and are contemplated by the inventors. Generally, combustion held by the perforated flame holder is very stable and no unusual sensing requirement is placed on the system. Combustion sensing may be performed using an infrared sensor, a video sensor, an ultraviolet sensor, a charged species sensor, thermocouple, thermopile, and/or other known combustion sensing apparatuses. In an additional or alternative variant of step 416, a pilot flame or other ignition source may be provided to cause ignition of the fuel and oxidant mixture in the event combustion is lost at the perforated flame holder.

Proceeding to decision step 418, if combustion is sensed not to be stable, the method 400 may exit to step 424, wherein an error procedure is executed. For example, the error procedure may include turning off fuel flow, re-executing the preheating step 402, outputting an alarm signal, igniting a stand-by combustion system, or other steps. If, in step 418, combustion in the perforated flame holder is determined to be stable, the method 400 proceeds to decision step 420, wherein it is determined if combustion parameters should be changed. According to an embodiment, one candidate for combustion parameter change is an amount of EFGR.

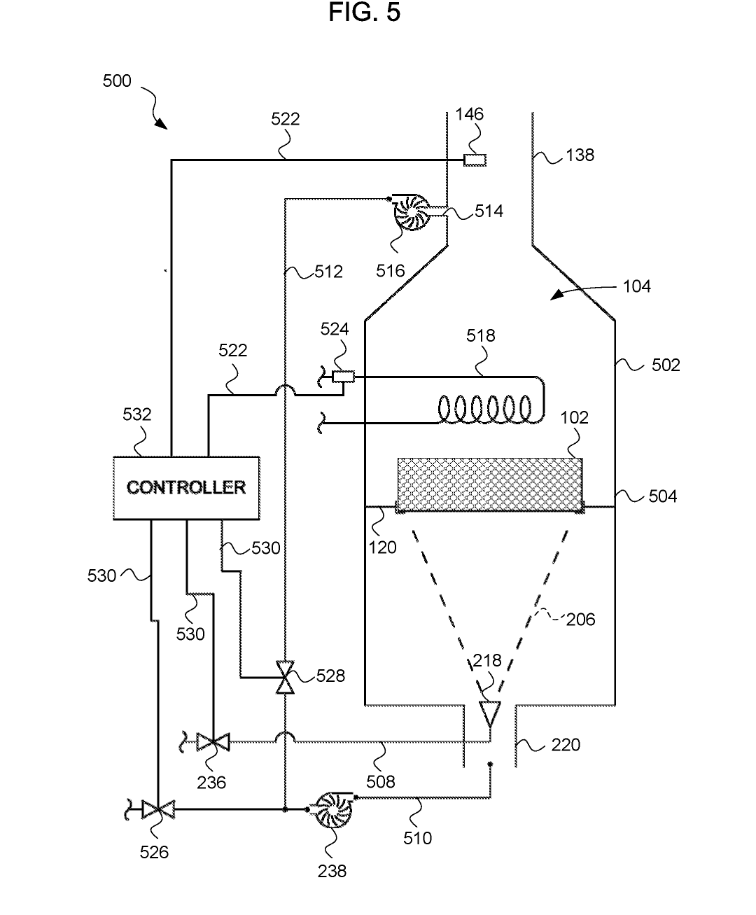

If no combustion parameters are to be changed, the method loops (within step 404) back to step 410, and the combustion process continues. If a change in combustion parameters is indicated, the method 400 proceeds to step 422, wherein the combustion parameter change is executed. For example, upon reaching stable combustion, an operator or an electronic controller can opt to begin to provide EFGR. In step 422, the combustion parameter change can thus include opening a damper (e.g., see FIG. 1, 134), operating a blower (e.g., see FIG. 5, 514), or other control operation to increase EFGR. After changing the combustion parameter(s), the method loops (within step 404) back to step 410, and combustion continues. The inventors found that changing the amount of EFGR gradually resulted in continued stable combustion. According to embodiments, the amount of EFGR may be limited to about 5% of total combustion air flow (e.g., see FIG. 1, 132). In another embodiment, the amount of EFGR may be limited to about 5% of total combustion air plus fuel flow. In any particular loop 410-422, the change in EFGR can be limited to an increment of 1% of total combustion air flow.

Combustion parameters may be scheduled to be changed, for example, if a change in heat demand is encountered. For example, if less heat is required (e.g., due to decreased electricity demand, decreased motive power requirement, or lower industrial process throughput), the fuel and oxidant flow rate may be decreased in step 422. Conversely, if heat demand is increased, then fuel and oxidant flow may be increased. Additionally or alternatively, if the combustion system is in a start-up mode, then fuel and oxidant flow may be gradually increased to the perforated flame holder over one or more iterations of the loop within step 404.

Referring again to FIG. 2, the burner system 200 includes a heater 228 operatively coupled to the perforated flame holder 102. As described in conjunction with FIGS. 3 and 4, the perforated flame holder 102 operates by outputting heat to the incoming fuel and oxidant mixture 206. After combustion is established, this heat is provided by the combustion reaction; but before combustion is established, the heat is provided by the heater 228.

Various heating apparatuses have been used and are contemplated by the inventors. In some embodiments, the heater 228 can include a flame holder configured to support a flame disposed to heat the perforated flame holder 102. The fuel and oxidant source 108 can include a fuel nozzle 218 configured to emit a fuel stream and an air source 220 configured to output combustion air adjacent to the fuel stream. The fuel nozzle 218 and air source 220 can be configured to output the fuel stream to be progressively diluted by the combustion air. The perforated flame holder 102 can be disposed to receive a diluted fuel and air mixture 206 that supports a combustion reaction that is stabilized by the perforated flame holder 102 when the perforated flame holder 102 is at an operating temperature. A start-up flame holder, in contrast, can be configured to support a start-up flame at a location corresponding to a relatively rich fuel and air mixture that is stable without stabilization provided by the heated perforated flame holder 102.

The burner system 200 can further include a controller 230 operatively coupled to the heater 228 and to a data interface 232. For example, the controller 230 can be configured to control a start-up flame holder actuator configured to cause the start-up flame holder to hold the start-up flame when the perforated flame holder 102 needs to be pre-heated and to not hold the start-up flame when the perforated flame holder 102 is at an operating temperature (e.g., when T≧T_{S}).

Various approaches for actuating a start-up flames are contemplated. In one embodiment, the start-up flame holder includes a mechanically-actuated bluff body configured to be actuated to intercept the fuel and oxidant mixture 206 to cause heat-recycling vortices and thereby hold a start-up flame; or to be actuated to not intercept the fuel and oxidant mixture 206 to cause the fuel and oxidant mixture 206 to proceed to the perforated flame holder 102. In another embodiment, a fuel control valve, blower, and/or damper may be used to select a fuel and oxidant mixture flow rate that is sufficiently low for a start-up flame to be jet-stabilized; and upon reaching an perforated flame holder 102 operating temperature, the flow rate may be increased to “blow out” the start-up flame. In another embodiment, the heater may include an electrical power supply operatively coupled to the controller 230 and configured to apply an electrical charge or voltage to the fuel and oxidant mixture 206. An electrically conductive start-up flame holder may be selectively coupled to a voltage ground or other voltage selected to attract the electrical charge in the fuel and oxidant mixture 206. The attraction of the electrical charge was found by the inventors to cause a start-up flame to be held by the electrically conductive start-up flame holder.

In another embodiment, the heater 228 may include an electrical resistance heater configured to output heat to the perforated flame holder and/or to the fuel and oxidant mixture 206. The electrical resistance heater can be configured to heat up the perforated flame holder 102 to an operating temperature. The heater 228 can further include a power supply and a switch operable, under control of the controller 230, to selectively couple the power supply to the electrical resistance heater.

An electrical resistance heater 228 can be formed in various ways. For example, the electrical resistance heater 228 can be formed from KANTHAL wire (available from Sandvik Materials Technology division of Sandvik AB of Hallstahammar, Sweden) threaded through at least a portion of the perforations 210 defined formed by the perforated flame holder body 208. Alternatively, the heater 228 can include an inductive heater, a high energy (e.g. microwave or laser) beam heater, a frictional heater, or other types of heating technologies.

Other forms of start-up apparatuses are contemplated. For example, the heater 228 can include an electrical discharge igniter or hot surface igniter configured to output a pulsed ignition to the air and fuel. Additionally or alternatively, a start-up apparatus can include a pilot flame apparatus disposed to ignite a fuel and oxidant mixture 206 that would otherwise enter the perforated flame holder 102. An electrical discharge igniter, hot surface igniter, and/or pilot flame apparatus can be operatively coupled to the controller 230, which can cause the electrical discharge igniter or pilot flame apparatus to maintain combustion of the fuel and oxidant mixture 206 in or upstream from the perforated flame holder 102 before the perforated flame holder 102 is heated sufficiently to maintain combustion.

The burner system 200 can further include a sensor 234 operatively coupled to the control circuit 230. The sensor 234 can include a heat sensor configured to detect infrared radiation or a temperature of the perforated flame holder 102. The control circuit 230 can be configured to control the heating apparatus 228 responsive to input from the sensor 234. Optionally, a fuel control valve 236 can be operatively coupled to the controller 230 and configured to control a flow of fuel to the fuel and oxidant source 108. Additionally or alternatively, an oxidant blower or damper 238 can be operatively coupled to the controller 230 and configured to control flow of the oxidant (or combustion air).

The sensor 234 can further include a combustion sensor operatively coupled to the control circuit 230, the combustion sensor being configured to detect a temperature, video image, and/or spectral characteristic of a combustion reaction held by the perforated flame holder 102. The fuel control valve 236 can be configured to control a flow of fuel from a fuel source 218 to the fuel and oxidant source 108. The controller 230 can be configured to control the fuel control valve 236 responsive to input from the combustion sensor 234. The controller 230 can be configured to control the fuel control valve 236 and/or oxidant blower or damper 238 to control a preheat flame type of heater 228 to heat the perforated flame holder 102 to an operating temperature. The controller 230 can similarly control the fuel control valve 236 and/or the oxidant blower or damper 238 to change the fuel and oxidant mixture 206 flow responsive to a heat demand change received as data via the data interface 232.

FIG. 5 is a diagram of a combustion system 500 with a perforated flame holder 102, and including EFGR, according to an embodiment. Many of the elements shown in FIG. 5 are provided as representative examples of elements that may be incorporated into the combustion system 500, depending upon the requirements of a particular application. The inclusion of these elements is not intended to suggest that every embodiment must necessarily include all the elements shown or described, nor that only the elements shown can be included in any embodiment.

The combustion system 500 includes a combustion volume 104 defined, primarily, by sidewalls 502 of a housing 504. The housing further includes an oxidant source 220 and a flue stack 138. A flame holder support structure 120 is configured to support the perforated flame holder 102 within the housing 504. A fuel nozzle 218 is positioned and configured to emit a fuel stream 206 toward the flame holder 102, and is coupled to a fuel source 218 via a fuel line 508. An air line 510 is coupled to the oxidant source 220 and is configured to provide an oxidant, such as air, to support the combustion of fuel within the combustion volume 104. An air blower 238 in the air line 510 can be employed to increase the pressure and volume of air introduced into the combustion volume 104. Air entering the combustion volume 104 via the oxidant source 220 is entrained by the fuel stream 206 and supports the combustion of the fuel in the perforated flame holder 102, as discussed in more detail below. Reference to the fuel stream is to be construed as referring also to any oxidants and/or diluents that are entrained therein. The term fuel and oxidant mixture may also be used to refer to the mixture of fuel and oxidants in the fuel stream 206.

An FGR line 512 is operatively coupled to the flue stack 138 at a first end and to the oxidant source 220 at a second end, and is configured to carry a quantity of flue gas from the flue stack 138 back to the oxidant source 220 to be reintroduced into the combustion volume 104. In the embodiment shown, the first end of the FGR line 512 is coupled to the flue stack 138 via an FGR duct 514 and an FGR blower 516. At its second end, the FGR line 512 is coupled to the air line 510 upstream of the air blower 238. The FGR blower 516 draws flue gas from the flue stack 138 and pressurizes the FGR line 512. Flue gas entering the air line 510 is mixed with incoming air as they pass through the air blower 238 before being introduced to the combustion volume 104.

Hereafter, the use of terms such as air, input air, etc., is to be construed broadly as referring to a fluid that includes oxygen, and that is to be introduced into a combustion volume to support a combustion reaction. Specifically, such a fluid can be ambient air, a mixture of ambient air with other fluids, i.e., flue gas or inert gas, etc.

A load 518, represented in FIG. 5 as a coiled heat exchanger, is positioned within the combustion volume 104 and is configured to draw heat energy produced by a combustion reaction within and around the perforated flame holder 102. The flue gas sensor 146 is positioned downstream from the flame holder 102 and is configured to detect or monitor any of a number of parameters within flue gas exiting the combustion volume 104, and to provide a corresponding signal on a sensor line 522. For example, the sensor 146 can be configured to detect one or more of temperature, oxygen level, NOx level, CO level, flow velocity, etc. Alternatively, some parameters can be more easily inferred from other detected values than by direct measurement. For example, based on tests performed on a given system, a level of NOx in the flue gas can be accurately inferred from measurements of temperature and O₂ levels.

A load output sensor 524 is positioned at an output of the load 518, and is configured to detect or monitor any of a number of parameters associated with the load, and to provide a corresponding signal on a respective sensor line 522. The fuel control valve 236 is positioned to control a flow in the fuel line 508 from a fuel source to the fuel nozzle 218, an air volume control valve 526 is positioned to control a flow air in the air line 510 from an air intake to the oxidant source 220, and an FGR control valve 528 is positioned to control a flow of flue gas in the FGR line 512 from the flue stack 138 to the oxidant source 220. Each of the control valves 236, 526, 528 are configured to be controlled by a signal on a respective control line 530.

A controller 532 is coupled to receive signals from the sensors 146, 524 via the respective sensor lines 522, and to provide corresponding control signals to the control valves 236, 526, 528 via the respective control lines 530. The controller 532 is configured to control operation of the combustion system 500, in part, in response to signals from sensors such as the flue gas sensor 146 and the load sensor 524.

The elements shown in FIG. 5 are positioned in the drawing to aid in clarity in the description. However, many of the elements can be positioned elsewhere in the system without significant change in operation. For example, the flue gas sensor 146 is shown in a position in the flue stack 138. In practice, the sensor 146 can be positioned elsewhere within the combustion volume 104, as long as it is located far enough downstream from the flame holder 102 to ensure that the combustion reaction is complete by the time the products thereof contact the sensor. Similarly, the FGR duct 514 can be located elsewhere within the downstream-portion of the combustion volume 104.

In operation, according to an embodiment, the controller 532 is configured to compare a signal from the load sensor 524 with a reference value or range of values to determine whether the output of the load 518 is within acceptable limits. For example, in an embodiment in which the load 518 is a component of a water boiler, the load sensor 524 may be configured to monitor one or more of temperature, flow rate, and/or “quality,” i.e., the ratio of steam to water at the load output. Assuming that the load sensor 524 is configured to monitor steam quality, if the quality drops below an acceptable value, i.e., the quantity of steam relative to water drops, the controller 532 can be configured to control the fuel control valve 236 to open further, increasing the volume of fuel emitted from the nozzle 218. This results in an increase of heat produced by the combustion reaction held by the perforated flame holder 102, delivering increased thermal energy to the load 518, which converts a greater percentage of the water into steam, thereby increasing the steam quality. Concurrently, the controller 532 can be configured to control the air volume control valve 526 to open further in order to increase the supply of air introduced into the oxidant source 220, in order to provide sufficient for the combustion reaction.

The operation sequence described above is appropriate in a situation in which a total load output is substantially fixed, i.e., a specific quantity of steam is desired. In a case in which a fuel quantity is either a fixed value or varies in response to factors that are external to the combustion system 500, then the controller 532 can be configured to control a flow of water to the load 518. In such a case, if the load sensor 524 detects a drop in output quality, the controller 532 can be configured to control a valve (not shown) to reduce a volume of water admitted to the load 518. With less water flowing through the load 518, a larger proportion of the water is converted to steam, thereby increasing output quality.

It is generally understood in the art that recirculation of flue gas can result in a reduction of NOx in a combustion reaction. Adding flue gas to the input air increases the volume relative to the quantity of O₂ in the resulting mix. The general understanding is that the increased volume acts as a heat sink, reducing the temperature of the combustion reaction, which results in a reduced production of NOx. According to an embodiment, the controller 532 is configured to regulate a flow of flue gas in the FGR line 512 according to the values of combustion parameters detected by the flue gas sensor. For example, if a signal from the flue gas sensor 146 indicates an increase in production of NOx, the controller 532 can be configured to control the FGR control valve 528 to increase a flow of flue gas in the FGR line 512. On the other hand, if the controller 532 determines that the level of is well below threshold levels, the controller can be configured to control the FGR control valve 528 to reduce the flow of flue gas, thereby reducing the efficiency losses associated with FGR.

Production of NOx is highly correlated with flame temperature and residence time. In fact, in many industrial combustion systems, NOx production is not directly measured, but is inferred from other data, including flame temperature and residence time. In the configuration shown in FIG. 5, the values for flame temperature and residence are themselves inferred based on factors that include the temperature detected by the flue gas sensor 146, and according to known characteristics of the combustion system 500. In other words, based on preliminary tests it can be established that for a given system, a given temperature detected by the flue gas sensor 146 will be strongly indicative of a specific corresponding flame temperature. Other relevant factors include the volume—and corresponding velocity—of fluid introduced via the oxidant source 220. This indirect method of temperature measurement can be beneficial because it does not require that a temperature sensor be exposed to the very high temperature of the combustion reaction, itself.

However, if other parameters of the system change, the accuracy of the temperature determination can be affected. For example, the heat load on the combustion system 500 varies according to the volume of fluid flowing through the working load 518. An increase in fluid volume increases the heat load, and more thermal energy is extracted by the working load 518. Assuming a constant flame temperature, an increased heat load will result in a lower temperature detected by the flue gas sensor 146.

Thus, according to another embodiment, the controller 532 is configured to integrate data from the load output sensor 524, in addition to data from the flue gas sensor 146 in controlling the flow of flue gas. The load sensor 524 is configured to detect steam quality and flow rate, and a correlation of these two values is used to determine the current heat load. This in turn is correlated with the temperature value detected by the flue gas sensor 146 to correct for changes in the measured temperature.

In the embodiment shown in FIG. 5, the volumes and ratio of air and flue gas are controlled by operation of respective control valves 236, 526, 528. According to an alternate configuration, the FGR control valve 528 is omitted, and the controller 532 is configured to control the flow of flue gas in the FGR line 512 by controlling the throughput of the FGR blower 516. Throughput can be controlled, for example, by controlling blower RPM or rotor blade pitch, etc. According to another embodiment, the FGR blower 516 is omitted. Operation of the air blower 238 produces a drop in air pressure directly upstream. This drop in pressure is sufficient to pull flue gas from the FGR line 512 into the air line 510, the volume of which is controlled by the FGR control valve 528.

According to a further embodiment, the FGR blower 516 and the FGR control valve 528 are both omitted. Instead, the controller 532 is configured to control throughput of the air blower 238, a manner similar that was described previously with reference to the FGR blower 516. The total volume of the air mixture introduced into the combustion volume 104 is controlled primarily by the air blower 238, while the ratio of air to flue gas is controlled by operation of the air volume control valve 526. For example, in order to increase the volume of recirculated flue gas, the controller 532 is configured to control the air volume control valve 526 to reduce the volume of air admitted. This results in a greater drop in air pressure upstream of the air blower 238, as the air volume control valve 526 chokes the input air. The pressure drop, in turn, draws an increased volume of flue gas from the FGR line 512, thus changing the ratio of air to flue gas.

According to an embodiment, the controller 532 is configured to control operation of the combustion system 500 to preheat the perforated flame holder 102 prior to normal operation. For example, during a start-up procedure, the controller can be configured to control the fuel control valve 236 to admit a flow of fuel reduced relative to a normal operating level, so that the volume and velocity of the resulting fuel stream 206 exiting the nozzle 218 are also reduced. This enables a preheat flame to be supported in the fuel stream 206 between the nozzle 218 and the flame holder 102. An ignition source, such as a spark generator, etc., is employed to ignite the preheat flame, which produces heat that is transmitted to the flame holder 102. When at least a portion of the flame holder 102 reaches a selected minimum operating temperature, the controller 532 controls the fuel control valve 236 to admit an increased flow of fuel appropriate for normal operation. The start-up flame, which becomes unstable in the increasing volume and velocity of the fuel stream 206, is extinguished or blown upward toward the flame holder 102. The minimum operating temperature is selected to be sufficiently high to cause auto-combustion when the fuel stream 206 comes into contact. Thus, a combustion reaction is ignited within the perforated flame holder 102. Principles of the operation of the flame holder 102 are discussed in more detail above, with reference to FIGS. 2 and 3.

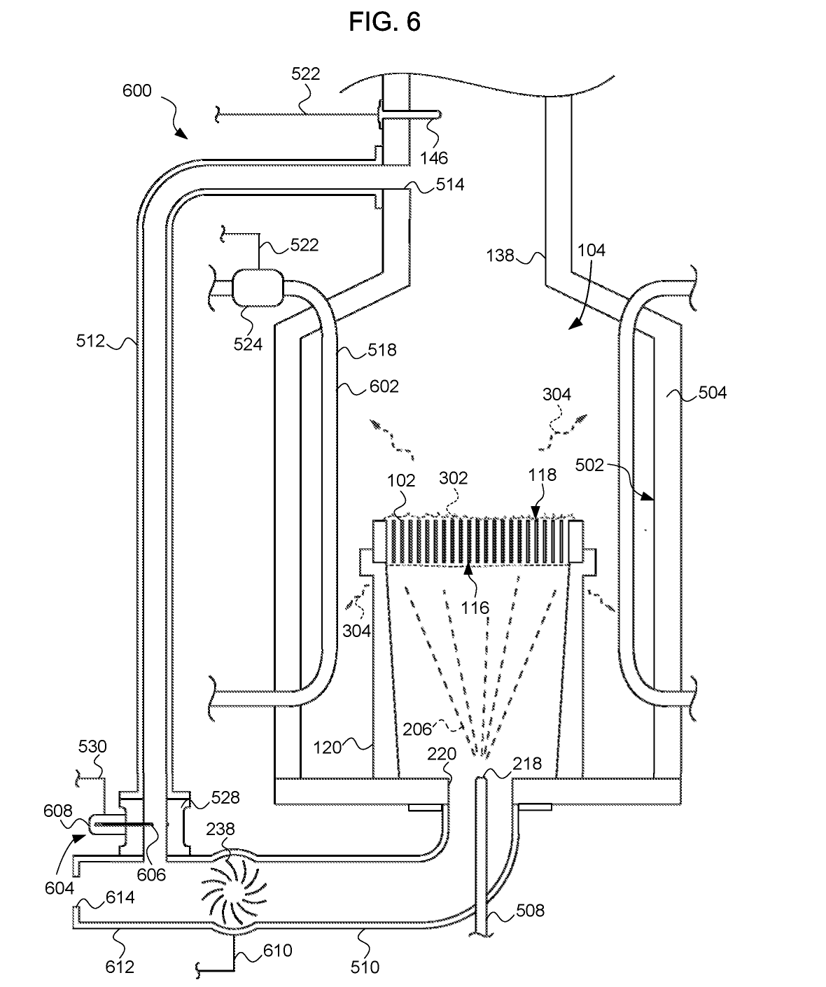

FIG. 6 is a side sectional diagram of a combustion system 600, according to an embodiment, which includes many features that correspond to features described above with reference to previous embodiments. In the combustion system 600, the load 518 is represented by a plurality of pipes 602 distributed around the perforated flame holder 102 and extending vertically within the combustion volume 104. Working fluid within the pipes 602, e.g., water, enters at inlets at the bottom, and rises within the pipes and passing through the load sensor 524 as it exits the combustion volume. Heat from the perforated flame holder 102, primarily in the form of radiant heat 304, is transmitted from the flame holder to the pipes 602, and the fluid inside.

In the embodiment of FIG. 6, the FGR control valve 528 is configured as a gate valve 604, and includes a sliding valve member 606 and an actuator 608 configured to control a position of the valve member 606 in response to a signal on a valve control line 530.

The combustion system operates substantially as described with reference to the embodiment of FIG. 5, except that the ratio of air to flue gas is controlled by the interaction of the air blower 238 and the FGR control valve 528. A control signal on a control line 610 regulates the RPM of the air blower 238, which in turn controls throughput of the blower. Low pressure produced by operation of the blower 238 draws flue gas from the FGR line 512 into the air line 510 upstream of the blower 238. The volume of flue gas is controlled by the position of the valve member 606 of the FGR control valve 528.

According to an embodiment, an air intake 612 has a relatively reduced intake aperture 614, which ensures that the blower 238 is able to draw down the air pressure at its upstream side, enabling a strong draught of recirculated flue gas into the air line 510.

In describing the embodiments illustrated in the drawings, directional references, such as right, left, top, bottom, etc., are used to refer to elements or movements as they are shown in the figures. Such terms are used to simplify the description and are not to be construed as limiting the claims in any way. Furthermore, while the drawings show respective embodiments with a perforated flame holder in a horizontal orientation and a fuel nozzle positioned below, embodiments are contemplated in which the combustion system is differently oriented, such as, for example, with the flame holder oriented vertically, and the nozzle is positioned to one side.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A combustion system, comprising:
a perforated flame holder disposed in a combustion volume defined by a combustion chamber wall, the perforated flame holder being configured to hold a combustion reaction supported by fuel and combustion air;
a fuel and oxidant source configured to output the fuel and combustion air into the combustion volume and arranged to cause the fuel and air to mix in a mixing volume between the fuel and oxidant source and the perforated flame holder; and
a flue gas recirculator configured to receive flue gas from a flue volume arranged to receive the flue gas from the combustion reaction held by the perforated flame holder and to output the flue gas for mixing with the fuel and air in the mixing volume.

2. The combustion system of claim 1, wherein the perforated flame holder is configured to hold, under at least a subset of operating conditions of the combustion system, the combustion reaction substantially between an input face and an output face of the perforated flame holder.

3. The combustion system of claim 1, further comprising a perforated flame holder support structure configured to support the perforated flame holder at a distance including the mixing volume away from the fuel and air source.

4. The combustion system of claim 1, wherein the flue gas recirculator comprises an external flue gas recirculation (EFGR) system.

5. The combustion system of claim 1, wherein the flue gas recirculator further comprises:
a pipe arranged to convey flue gas received from an aperture in a flue wall adjacent to the flue volume to an output point for mixing with incoming combustion air.

6. The combustion system of claim 1, wherein the flue gas recirculator comprises:
a pipe arranged to convey flue gas received from an aperture in a flue wall adjacent to the flue volume to the fuel and air source.

7. The combustion system of claim 1, wherein the flue gas recirculator comprises:
a pipe arranged to convey flue gas received from an aperture in a flue wall adjacent to the flue volume to the mixing volume.

8. The combustion system of claim 1, further comprising:
a blower configured to receive the flue gas and input air, and to output the flue gas and input air into the fuel and air source.

9. The combustion system of claim 1, wherein the flue gas recirculator further comprises:
a blower arranged to suck flue gas from the flue gas volume and output the flue gas for mixing with the fuel and air prior to receipt of the mixed fuel, air, and flue gas at an input face of the perforated flame holder.

10. The combustion system of claim 1, wherein the flue gas recirculator further comprises a recirculation valve or damper configured to control the flow of flue gas through the flue gas recirculator.

11. The combustion system of claim 1, further comprising:
a damper configured to control a flow of flue gas out a stack to the atmosphere.

12. The combustion system of claim 1, further comprising:
a start-up apparatus configured to pre-heat the perforated flame holder during start-up from a temperature below a nominal operating temperature of the perforated flame holder.

13. The combustion system of claim 12, further comprising:
a controller operatively coupled to the start-up apparatus and a recirculation valve or damper;
wherein the controller is configured to substantially prevent external recirculation of flue gas while the start-up apparatus is pre-heating the perforated flame holder.

14. The combustion system of claim 12, further comprising:
a controller operatively coupled to the start-up apparatus and a blower;
wherein the controller is configured to control the blower to substantially prevent external recirculation of flue gas while the start-up apparatus is pre-heating the perforated flame holder.

15. The combustion system of claim 1, further comprising:
a controller;
a flue gas sensor operatively coupled to the controller; and
at least one apparatus configured to control a flow of flue gas into the combustion volume;
wherein the controller is configured to control the at least one apparatus to cause flue gas to flow into the combustion volume only when the flue gas sensor outputs a signal indicating that the perforated flame holder is at a nominal operating temperature or above.

16. The combustion system of claim 15, wherein the sensor comprises a stack temperature sensor.

17. The combustion system of claim 15, wherein the sensor comprises a carbon monoxide sensor.

18. The combustion system of claim 1, further comprising:
a radiantly-heated heat load configured to receive infrared radiation from the perforated flame holder; and
a convectively-heated heat load configured to receive heat from hot combustion products output by the combustion reaction held by the perforated flame holder.

19. The combustion system of claim 1, wherein the combustion system comprises a once-through-steam-generator.

20. A combustion system, comprising:
a perforated flame holder having an input face, an output face lying opposite the input face, and a plurality of perforations extending through the flame holder between the input and output faces, the flame holder being positioned within a combustion volume and configured to hold a combustion reaction substantially within the plurality of perforations;
a nozzle positioned and configured to emit a fuel stream toward the input face of the perforated flame holder;
an oxidant source configured to introduce a fluid including an oxidizer into the combustion volume; and
a flue gas recirculation channel having a first end in fluid communication with the combustion volume downstream of the perforated flame holder and a second end in fluid communication with the oxidant source.

21. The combustion system of claim 20, comprising a flue gas sensor positioned within a path of a flow of combustion products from the perforated flame holder and configured to produce a signal corresponding to at least one combustion parameter of a combustion reaction held by the flame holder.

22. The combustion system of claim 21, comprising a controller configured to receive the signal from the flue gas sensor and to regulate a volume of flue gas flowing in the flue gas recirculation channel according to a value of the signal.

23. The combustion system of claim 21, wherein the flue gas sensor is configured to produce a signal corresponding to at least one of a flue gas temperature, a level of oxygen within the flue gas, a level of carbon monoxide within the flue gas, and a level of oxides of nitrogen within the flue gas.

24. The combustion system of claim 21, wherein the flue gas sensor comprises a plurality of sensors, each configured to produce a signal corresponding to a respective one of a plurality of combustion parameters.

25. The combustion system of claim 20, comprising a flue gas blower operatively coupled to the flue gas recirculation channel and configured to impel a flow of flue gas within the channel.

26. The combustion system of claim 20, comprising a flue gas control valve operatively coupled to the flue gas recirculation channel and configured to selectively restrict a flow of flue gas within the channel.

27. The combustion system of claim 20, comprising a flue gas control valve operatively coupled to the flue gas recirculation channel and configured to restrict a flow of flue gas within the channel.

28. The combustion system of claim 20, comprising an air blower operatively coupled to the oxidant source and configured to impel a flow of air through the oxidant source and into the combustion volume.

29. The combustion system of claim 28, wherein the second end of the flue gas recirculation channel is coupled to an air intake channel upstream of an intake port of the air blower.

30. The combustion system of claim 29, wherein the air blower is a variable throughput blower configured to vary an air throughput according to a control signal at a control input terminal.

31. The combustion system of claim 29, comprising a flue gas control valve operatively coupled to the flue gas recirculation channel and configured to selectively restrict a flow of flue gas within the channel.

32. The combustion system of claim 31, comprising a controller configured to control a ratio of air to flue gas introduced into the combustion volume, by controlling a throughput of the air blower and a degree of restriction of the flow of flue gas by the flue gas control valve.

33. The combustion system of claim 20, comprising a working load positioned to receive heat produced by a combustion reaction held by the perforated flame holder.

34. The combustion system of claim 33, wherein the working load is positioned within the combustion volume.

35. The combustion system of claim 34, comprising a load sensor positioned at an output of the working load and configured to produce a signal corresponding to a parameter of the working load.

36. The combustion system of claim 35, wherein the load sensor is configured to produce the signal corresponding to a quantity of heat energy received by the working load.

37. A method, comprising:
emitting a fuel stream toward a flame holder positioned within a combustion volume;
introducing a quantity of oxidizer fluid into the combustion volume;
entraining a portion of the quantity of oxidizer fluid into the fuel stream;
combusting the fuel stream substantially within a plurality of perforations extending through the flame holder;
separating a quantity of flue gas that includes products of the combustion from a location in the combustion volume that is downstream from the flame holder; and
producing the quantity of oxidizer fluid by including the quantity of flue gas in a mixture of gases comprising the oxidizer fluid.

38. The method of claim 37, wherein the producing the quantity of oxidizer fluid comprises mixing the quantity of flue gas with a quantity of ambient air.

39. The method of claim 37, comprising:
detecting at least one parameter of the combustion; and
selecting the quantity of flue gas according to a value of the detected parameter.

40. The method of claim 39, wherein the detecting at least one parameter of the combustion comprises detecting one or more of a flue gas temperature, a flue gas oxygen value, a flue gas oxides of nitrogen value, and/or a flue gas carbon monoxide value.

41. The method of claim 39, wherein the selecting the quantity of flue gas comprises controlling a quantity of flue gas flowing in a flue gas recirculation channel configured to carry flue gas to an oxidant source of the combustion volume.

42. The method of claim 41, wherein the controlling a quantity of flue gas flowing in a flue gas recirculation channel comprises controlling a valve that is operatively coupled to the flue gas recirculation channel.

43. The method of claim 41, wherein the controlling a quantity of flue gas flowing in a flue gas recirculation channel comprises controlling a throughput of a blower that is operatively coupled to the flue gas recirculation channel.

44. The method of claim 41, wherein the producing the quantity of oxidizer fluid comprises introducing the flue gas flowing in the flue gas recirculation channel into an air intake channel in fluid communication with the oxidant source of the combustion volume.

45. The method of claim 44, wherein the controlling a quantity of flue gas flowing in a flue gas recirculation channel comprises controlling a pressure difference between the air intake channel and the flue gas recirculation channel.

46. The method of claim 44, wherein the controlling a pressure difference between the air intake channel and the flue gas recirculation channel comprises controlling a throughput of an blower configured to impel the oxidizer fluid toward the oxidant source of the combustion volume.
